(19) United States
(12) Patent Application Publication
(10) Pub. No.: US 2017/0249656 A1
(43) Pub. Date: Aug. 31, 2017

(54) Dynamic Reverse Royalty Allocation Systems and Methods

(71) Applicant: kulaBrands, Inc., Fountain Hills, AZ (US)

(72) Inventors: Peter A. Gantner, Fountain Hills, AZ (US); Douglas D. Kyle, Fountain Hills, AZ (US)

(21) Appl. No.: 15/441,735

(22) Filed: Feb. 24, 2017

Related U.S. Application Data
(60) Provisional application No. 62/300,004, filed on Feb. 25, 2016.

(51) Int. Cl. G06Q 30/02; G06Q 50/00; G06Q 10/10; H04L 29/06

(52) U.S. Cl. CPC G06Q 30/0231; H04L 63/102; G06Q 30/0279; G06Q 50/01; G06Q 10/101

(57) ABSTRACT

Example devices, systems, and methods are provided for dynamic reward allocation among an online community of users performing collaborative online user actions. One example method involves monitoring user activity in a plurality of electronic publishing platforms including a crowdfunding platform and a social networking platform. The method also involves determining and storing point values for a detected content submission associated with a stored user profile. The point values are weighted according to at least a submission time of the detected content submission. The method also involves detecting a royalty distribution event. The method also involves allocating a royalty amount indicated in the detected event to a given user profile based on stored point values, of the user profile and other user profiles, that are associated with submission times prior to a royalty distribution time indicated in the detected event.

### CROSS-REFERENCE TO RELATED APPLICATION

This application claims priority to U.S. Prov. Pat. App. No. 62/300,004 filed on Feb. 25, 2016, the entirety of which is incorporated herein by reference.

### FIELD

The present disclosure relates generally to dynamic evaluation of online user activity, and more specifically, methods and systems for dynamic evaluation of collaborative online user actions by monitoring electronic content submissions published at third-party electronic publishing platforms.

### BACKGROUND

Advances in internet-based communication platforms provide alternative processes for launching a new product and/or funding a product development project. Internet-based crowdfunding platforms, such as Kickstarter® and Indiegogo®, allow a user to present a project to the public, and to receive crowdfunding contributions directly from the viewing public toward a target amount for funding development of the project. Internet-based e-commerce platforms, such as Amazon® and eBay®, allow a user to present a product to the public and conduct sales transactions of the product directly with the viewing public. Social media networking platforms, such as Facebook® and Twitter®, allow a user to present a product to tens, hundreds, or even millions of other users, and then combining comments about the product from these users in a dynamically updated interface displayed to the public.

### SUMMARY

In one example, a method is described involves a computing system storing a plurality of user profiles. A given user profile may include user credentials that identify content submissions by a given user at a plurality of external electronic publishing platforms including a crowdfunding platform and a social networking platform. The method also involves causing a given user interface for the given user profile to display an indication of a predefined project publishable at the crowdfunding platform and related to development of a particular product or service. The method also involves monitoring the plurality of external electronic publishing platforms to detect content submissions that match respective user credentials in the stored plurality of user profiles. The method also involves detecting a content submission that includes content referencing the particular product or service. The method also involves determining a point value for the content submission. The point value may be weighted according to at least a submission time of the content submission. The method also involves storing user activity data indicating the determined point value, the submission time, and a mapping of the determined point value to the given user profile. The method also involves receiving royalty distribution messages related to sale of the particular product or service, and indicative of a royalty amount and a distribution time. The method also involves allocating the royalty amount between one or more of the plurality of user profiles based on stored point values in the user activity data associated with submission times prior to the distribution time.

In another example, a method is described that involves storing a plurality of user profiles. A given user profile includes user credentials that identify content submissions by a given user at a crowdfunding platform and a social networking platform. The method further involves monitoring the crowdfunding platform and the social networking platform to detect content submissions that include content related to a predetermined product or service. The method further involves determining a point value for a content submission detected based on the monitoring. The point value may be weighted according to at least a submission time of the content submission and a sum of previously pledged amounts published by the crowdfunding platform prior to the submission time. The method further involves storing user activity data indicating the determined point value, the submission time, and a mapping of the determined point value to a corresponding user profile. The method further involves receiving royalty distribution data indicative of a royalty amount and a distribution time. The operations further comprise determining respective point balances of the plurality of user profiles based on stored point values in the user activity data associated with submission times prior to the distribution time. The method further involves allocating a portion of the royalty amount to the given user profile based on a ration of a determined point balance of the given user profile to a sum of point balances of the plurality of user profiles.

In yet another example, a method is described that involves a computing system monitoring aggregated content published by an electronic publishing platform that aggregates user-submitted content together with user identifiers. The monitored aggregated content may relate to a predetermined product or service. The method also involves storing a plurality of user profiles mapped to user activity pertaining to the predetermined product or service. A first user profile may include a first user identifier of a first user. The method also involves filtering a plurality of content submissions from the aggregated content. The plurality of content submissions may be filtered based on the plurality of content submissions being associated with respective user identifiers corresponding to at least one user identifier in the stored plurality of user profiles. The method also involves, for each filtered content submission having the first user identifier, determining a point value based on at least a submission time of the content submission, and storing an indication of the determined point value mapped to the first user profile in the user activity data. The method also involves detecting a royalty distribution event related to a sale of the predetermined product or service and indicative of a royalty amount and a distribution time. The method also involves determining a first sum of point values mapped to the first user profile and corresponding to content submissions prior to the distribution time. The method also involves determining a second sum of point values mapped to any of the plurality of user profiles and corresponding to content submissions prior to the distribution time. The method also involves allocating a portion of the royalty amount to the first user profile based on at least a comparison of the first sum and the second sum.

These as well as other aspects, advantages, and alternatives, will become apparent to those of ordinary skill in the art by reading the following detailed description, with reference where appropriate to the accompanying figures.

### BRIEF DESCRIPTION OF THE FIGURES

FIG. 1 is a simplified block diagram of a computing system, in which various embodiments described herein can be employed.

FIG. 2 is a simplified block diagram of a device that can be used for communicating with a user activity collaboration server, according to an example embodiment.

FIG. 3 is a simplified block diagram of a user activity collaboration server, according to an example embodiment.

FIG. 4 is a flowchart of a method, according to an example embodiment.

FIG. 5 is a flowchart of another method, according to an example embodiment.

### DETAILED DESCRIPTION

The following detailed description describes various features and functions of the disclosed implementations with reference to the accompanying figures. In the figures, similar symbols identify similar components, unless context dictates otherwise. The illustrative implementations described herein are not meant to be limiting. It may be readily understood by those skilled in the art that certain aspects of the disclosed implementations can be arranged, substituted, separated, and combined in a wide variety of different configurations.

### I. Overview

While the prevalence and diversity of internet-based communication platforms provides alternative ways to reach an audience, challenges exist for successfully launching a project by relying on such platforms. For instance, in some crowdfunding platforms, fewer than half user-submitted projects achieve their desired crowdfunding goal. Among other reasons, users of these platforms face various technical challenges.

As an example, a project that relies on an online crowdfunding platform to raise funds may be only one of hundreds, thousands, or more projects presented on the platform on any given day. Thus, users of the crowdfunding platform might only focus on projects that accumulate a large number of pledges or interest in shortly after launch of the project on the crowdfunding platform. However, in some scenarios, it may be difficult or impossible to predict when a sufficient number of users of the platform are likely to view and notice a project submission, especially, for instance, if the users are located in multiple geographic regions that have different time zones.

As another example, although a project could be promoted via a social media campaign to reach as many users as possible at an early stage, it may be technically challenging to engage and encourage hundreds, thousands, or more social network users distributed over multiple geographic time zones and over multiple internet-based social network platforms to notice, submit, and/or interact with a social media post in a timely or coordinated manner.

Thus, it may be desirable for a computing system to provide a communication medium for notifying, coordinating, and monitoring online user actions, such as social network post interactions and crowdfunding platform pledges for a particular project. By doing so, for instance, the online presence of the project could gain sufficient momentum at an early stage, which may then increase the likelihood of other online users noticing and contributing to the development and product launch goals of the project.

In addition to these technical challenges, the upfront costs for reaching a large audience and capturing their attention in a short period of time may present a practical challenge for a start-up that has limited resources. Thus, it may also be desirable for the computing system to track and reward users who contribute to the product launch and development cycle within a specified time window and/or earlier than other users, while also postponing the upfront costs needed to motivate hundreds or thousands of users to perform these various online actions. By doing so, for instance, users could still be motivated to submit the various social network posts, contribute sufficient crowdfunding pledges, and/or purchase the product or service, in a timely, early, and coordinated effort. As a result, online crowdfunding, branding, and/or marketing effort can be coordinated to create a sufficient and timely online presence momentum, thereby increasing the likelihood of other users noticing the new product or service.

However, it may be technically challenging to monitor multiple user actions published via multiple internet-based platforms simultaneously, while also tracking when each user action occurred relative to other user actions and computing a dynamically varying reward for each user action. For instance, internet-based platforms may have different and non-uniform graphical user interfaces and/or methods of notification (e.g., email, text message, etc.) for publishing the various user interactions. Additionally, for instance, hundreds, thousands, or more user actions (e.g., social network posts, crowdfunding pledges, online sales, etc.) related to the same project may occur in a short period of time (e.g., seconds, minutes, etc.) and at multiple different platforms during that short period of time.

To overcome these challenges, the present disclosure provides example device, system, and method implementations for coordinating, assigning, monitoring, and/or dynamically evaluating online user actions related to a predefined project that involves development, branding, and/or marketing a particular product or service. One example computing system may store, in a database, a plurality of user profiles for a plurality of users of the computing system. Each user profile may include an indication of user credentials, such as an email address, username, social network account information, etc., that are used to identify content submissions (e.g., social network posts, crowdfunding pledges, etc.) published by a plurality of electronic publishing platforms.

In some instances, the computing system can also provide user-specific graphical user interfaces (GUIs) that display potential projects and allow users to vote or pre-pledge support for a particular project (e.g., pre-pledge a crowdfunding contribution amount, a number of social network posts, a purchase of one or more items, etc.). In these instances, the computing system can also initiate launch of the project after a threshold number of user votes or pre-pledges are achieved for a desired momentum after the launch. For example, an application programming interface (API) of the system can connect to an external crowdfunding platform to release or publish a new project after the system determines that a sufficient number of users are expected to submit crowdfunding pledges, social network posts, and/or purchases of the product to achieve a desired goal or online momentum. Through this process, a product developer or other submitter of the project can expect a higher likelihood of achieving the desired goals before actually launching the project on any number of electronic publishing platforms.

Further, some example implementations described herein involve monitoring online user actions across multiple electronic publishing platforms simultaneously, and assigning a dynamically weighted point value for a given user action depending on a combination of factors. A non-exhaustive list of factors includes: an occurrence time of the user action, occurrence times of other user actions, a current status of a predefined online activity milestone (e.g., target crowdfunding pledges total for a project), whether a content submission included predefined downloadable media content, the type of user action (e.g., crowdfunding pledge, social network post, etc.), among other factors. As noted above, in some instances, the online user actions may occur frequently across multiple and different types of third party online platforms, such as crowdfunding platforms, social media platforms, and/or online user-managed e-commerce platforms (e.g., eBay®, Amazon®, etc.), among others. In turn, for instance, the dynamically weighted point values determined for each detected user action may vary depending on prior detected user actions performed by the same user and/or other users at any one of the multiple electronic platforms.

Some example implementations may also involve rewarding timely and/or coordinated user activity by distributing royalty payments, intermittently or periodically, according to point values accumulated by a given user relative to point values accumulated by other users prior to a distribution time of the royalty payment. Further, in some examples, such royalty distribution events may occur while users are submitting publishable content (e.g., social network posts, crowdfunding pledges, etc.) across the multiple monitored electronic platforms. For instance, the royalty distribution payments can be triggered frequently and/or intermittently based on various events such as receiving a message or communication from an online webstore server indicating a sale of a relevant product, a batch sale report received from a distributor (e.g., department store network, etc.), a periodic (e.g., quarterly) or intermittent royalty payment message received from a producer of the product, among other possibilities. In some examples herein, the process of rewarding user actions based on future royalty payments may be referred to as a “reverse royalty reward system.”

Therefore, it is not possible for a human operator to monitor all the different electronic publishing platforms simultaneously to detect hundreds, thousands, or more content submissions by users of the system within a short period of time (e.g., minutes, seconds, or less than a second), while also: keeping track of submission times of user-submitted content (e.g., pledges, social network posts, etc.) in all platforms relative to one another, incorporating the submission times and the other factors described above to calculated an individually weighted point value for each detected content submission, and also determining royalty payments for every user in a meaningful way. Thus, this derivation of the associated royalty amount to pay out per user is necessarily rooted in computer technology, and requires computer interaction for payments to be processed in a meaningful way to achieve payout in a reasonable time.

Through this process, for instance, an example computing system can reward users who perform online actions sooner than other users and/or during a predefined time window that the system indicates to hundreds, thousands, or more users such that the users perform the target user actions in a timely and coordinated manner. As a result, for instance, the system may increase the likelihood of achieving a high momentum of online presence for a project across multiple electronic publishing platforms simultaneously.

Other examples are possible as well and are described in greater detail within exemplary implementations of the present disclosure.

### II. Example Systems and Devices

In some examples, the methods, devices, and systems described herein can be implemented using client devices and/or server devices (e.g., cloud-based servers, etc.). In some instances, client devices may offload some processing and storage responsibilities to one or more remote server devices. In some implementations, client services are configured to communicate, via a network such as the Internet or any other public or private network (e.g., intranet, etc.), with the server device(s). Thus, for instance, applications that operate on the client devices may also have a server-based component. Alternatively, one or more of the methods, processes, and techniques herein may be implemented entirely on a client device or a server device.

It is noted that the “server devices” described herein may not necessarily be associated with a client/server architecture, and therefore may also be referred to as “computing devices” or “remote servers” or “remote devices.” Further, “client devices” described herein may not necessarily be associated with a client/server architecture, and therefore may be interchangeably referred to as “user devices” or “computing devices.”

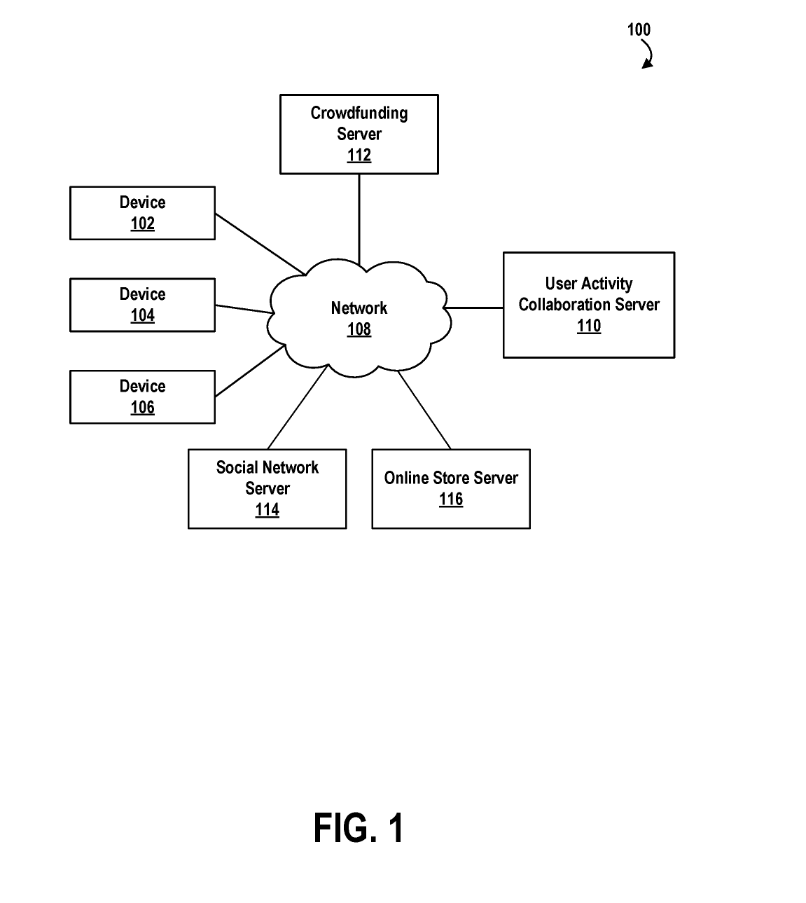

Referring now to the Figures, FIG. 1 is a simplified block diagram of a computing system 100, in which various embodiments described herein can be employed. System 100 includes client devices 102, 104, and 106, which may include desktop personal computers (PC), laptop PCs, hand-held devices (e.g., personal digital assistants), mobile phones, wearable devices (e.g., smart watches, etc.), tablet computers, wearable computing devices, or any other electronic device equipped with a network communication interface. Each of these client devices may be configured to communicate with other devices via a network 108 through the use of wireline connections and/or wireless connections.

Network 108 may include, for example, the Internet or some other form of public or private network (e.g., intranet). Thus, devices 102, 104, and 106 may communicate using packet-switching technologies (e.g., Internet Protocol (IP) network, etc.), or using any other network communication technology supported by network 108. In some implementations, network 108 may also incorporate at least some circuit-switching technologies (e.g., gateways, etc.), and devices 102, 104, and 106 may communicate via circuit switching alternatively or in addition to packet switching. Other implementations of network 108 are possible as well.

Although only three client devices are shown, system 100 may include any number of client devices. For instance, system 100 may comprise one, tens, hundreds, thousands, millions, or any other number of client devices.

As shown, one or more user activity collaboration server devices 110 may also communicate via network 108. In one example, server device 110 may communicate with client devices 102, 104, and 106 according to one or more network protocols and/or application-level protocols to facilitate the use of network-based or cloud-based computing on these client devices. Server device 110 may include integrated data storage (e.g., memory, disk drives, etc.) and/or may access a separate server data storage device (not shown). Communication between server device 110 and a separate server data storage device (not shown) may be direct, via network 108, via another network (not shown), or both direct and via network 108.

In one example, server device 110 may be configured to provide a user interface (e.g., graphical user interface) to any of devices 102, 104, 106 via network 108. Each user interface (UI) may display a listing of projects or products to a respective user along with various electronic publishing platforms where a product or project is published and a base point value for user content submissions in such platforms, for instance. In another example, server device 110 may comprise a control server configured to monitor user activity on crowdfunding server 112, social network server 114, and/or online store server 116.

In one instance, server 110 may access a crowdfunding website hosted on server 112 intermittently or periodically to download a list of users who pledged a crowdfunding amount. In another instance, one or more of servers 112, 114, and/or 116 may provide a application programming interface (API) specifically designed to transmit such information from server 112, 114, and/or 116. In this instance, server 110 may access the API to download the relevant information, condition the received data having various platform-specific formats, filter the conditioned data for content submissions by users of server 110, and then update a record for each user that is used to determine weights for weighting reward points awarded to the respective user. In yet another instance, server 110 may include a software interface that automatically extracts and filters data (e.g., dynamic website output format, comma-separated file format of data that can be downloaded from server 112, 114, and/or 116, etc.). Depending on a format of the output provided by the particular server 112. 114. 116, server 110 can condition the data into a uniform format that can be stored and accessed quickly. For example, server 110 can filter the extracted outputs to identify user submissions of users that have user profiles stored in server 110 (e.g., users that receive the UIs).

As noted above, server 110 may communicate with one or more electronic publishing platforms including crowdfunding server(s) 112, social network server(s) 114, and online store server(s) 116. Crowdfunding server 112, for example, may correspond to a server that hosts a website of a crowdfunding platform. To that end, server 112 may publish a listing of user contributions or crowdfunding pledges for a particular project, product, or service monitored by server 110. Alternatively or additionally, server 112 may include an API that server 110 can interface with to obtain a listing of users who pledged crowdfunding amounts for the project, etc. Alternatively or additionally, server 112 may include an email server configured to send notification emails to server 110 when a user pledges a crowdfunding contribution to a particular project monitored by server 110.

Social network server 114 may perform similar functions to those of server 114. However, unlike server 112, server 114 may be configured to display comments or social network posts by users who submit content related to the particular project or product monitored by server 110. Online store server 116 may correspond to a server device that manages and/or publishes details of a sales transaction. The sales transaction, for instance, may be for a product or service monitored by server 110. To that end, server 116 may provide similar functions as server 112, including for instance, an API, a website hosting server that publishes sales transactions, an email server, etc.

In some examples, as shown, servers 110, 112, 114, and 116 are each implemented as a single server device. Alternatively or additionally, one or more of servers 110, 112, 114, 116 can be physically implemented as multiple separate servers that are each assigned to various functions, or that are each configured to execute a respective portion of the functions and processes described herein.

For example, server device 110 may comprise one or more control servers and one or more data storage servers. Further, for example, server 110 of system 100 may be configured to communicate and/or monitor multiple crowdfunding servers 112, multiple social network servers 114, and/or multiple online store servers 116. In this example, each crowdfunding server 112 may be associated with a different crowdfunding platform that has a different output format, each social network server 114 may be associated with a different social network platform, and each online store server 116 may be associated with a different online store platform. To that end, for example, monitoring server 110 may include platform-specific APIs that can access, monitor, download content, etc., from according to the platform-specific protocols of any particular crowdfunding platform (e.g., Kickstarter®, Indiegogo®, etc.) social network platform (e.g., Facebook®, Twitter®, etc.), and/or online store platform (e.g., Amazon®, eBay®, etc.).

Further, in implementations where any of servers 110, 112, 114, 116 includes multiple servers, the servers may communicate with one another directly, via network 108, via another network (not shown), or both directly and via network 108, among other possibilities.

In alternative implementations, the functions of one or more of servers 110, 112, 114, 116 can be combined and/or performed by fewer servers (e.g., a single server, etc.).

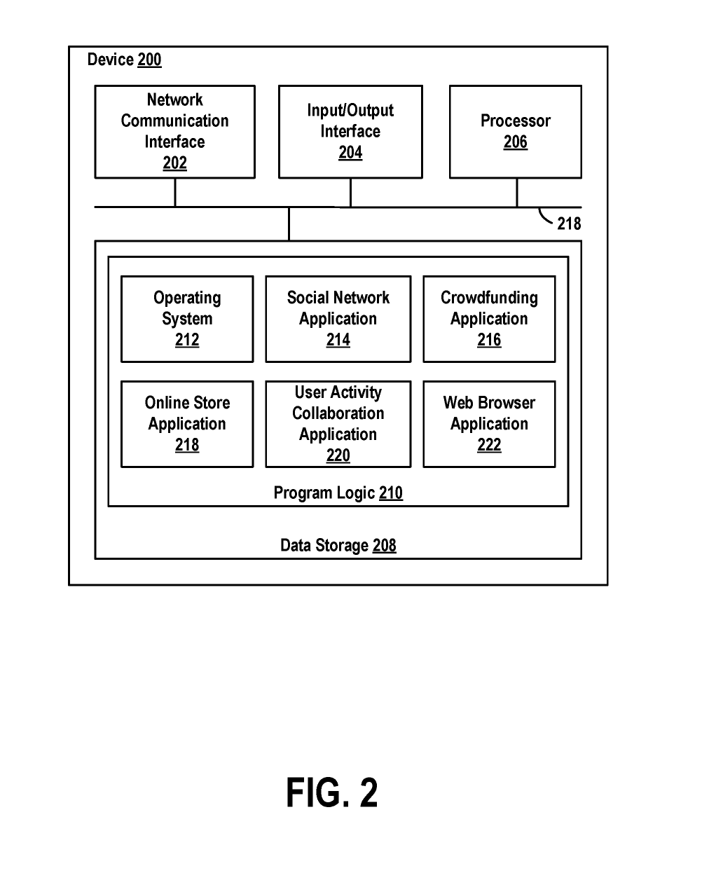

FIG. 2 is a simplified block diagram of a device 200 that may be used for communicating with a user activity collaboration server, according to an example embodiment. Device 200 may be similar to any of the devices 102, 104, 106. In some implementations, the various components shown may be distributed across multiple devices. Thus, the various components are shown as part of one device only for the sake of example. Further, it is noted that the functions described for the various components of device 200 may be combined or separated such that the functions are performed by fewer or more components than those shown.

Device 200 may include any computing device such as a telephone, a personal computer, or a personal digital assistant, among others. As shown, device 200 includes a network communication interface 202, an input/output (I/O) interface 204, a processor 206, and data storage 208, all of which may be communicatively linked together by a wired and/or wireless system bus, network, or other connection mechanism 218.

Communication interface 202 may be configured to allow device 200 to communicate with a network (e.g., network 108), such as an access network, a transport network, and the like. In one example, communication interface 202 may include a chipset and antenna arranged for wireless communication with a radio access network (RAN) or any other wireless access point. In another example, interface 202 may include an Ethernet interface arranged to couple with a landline or wired connection that provides connectivity with one or more networks. Other implementations of interface 202 are possible as well, including various hardware/software configurations used in various wired/wireless communication technologies.

I/O interface 204 may be configured to allow device 200 to interact with a user of the device 200. For example, I/O interface 204 may allow device 200 to receive user input(s) and to provide output(s). As such, I/O interface 204 may include input components such as a keypad or keyboard, a touch-sensitive panel, a microphone, a video camera, a touch screen, etc. Additionally or alternatively, I/O interface 204 may include output components such as a display screen and/or a sound speaker, among others.

Processor 206 may comprise one or more processors. In one implementation, processor 206 may comprise a single or multi-core processor, an application specific integrated circuit (ASIC), field programmable gate array (FPGA), and/or any other suitable circuitry.

Data storage 208 may include one or more volatile and/or non-volatile storage components, such as magnetic, optical, flash, organic storage, and the like. In some implementations, data storage 208 may be configured as a non-transitory computer readable medium. In some implementations, data storage 208 may be integrated in whole or in part with processor 206. As shown, data storage 208 includes program logic 210. In some implementations, data storage 208 may include additional stored data, such as social network account information (e.g., username, password, etc.), user activity collaboration network account information, online store account information, and/or any other information.

Program logic 210 may take the form of machine language instructions or other logic executable or interpretable by processor 206 to carry out various functions and methods described herein. By way of example, as shown, program logic 210 may include an operating system 212 and one or more application programs, exemplified by social network application 214, crowdfunding application 216, online store application 218, user activity collaboration application 220, and web browser application 216. Thus, as shown, program logic 210 may be distributed among operating system 212, application programs 214, 216, 218, 220, 222, and/or one or more other software components (not shown). In some implementations, program logic 210 may be executable by processor 206 to cause the device 200 to perform various functions of device 200, in accordance with the present disclosure.

Operating system 212 may include various instructions or logic for operation of the various components of device 200, and/or for facilitating communication between the various components or applications of device 200 (e.g., via connection mechanism 218, etc.).

Social network application 214 can be optionally included in device 200 to provide instructions for operating I/O interface 204 and/or other components of device 200. In one example, application 214 may include instructions for rendering a display of social network post(s) via a display included in or operated by interface 204. In another example, social network application 214 may include instructions for generating an input interface (e.g., graphical user interface) for receiving and/or validating a social network post submission.

Crowdfunding application 216 can be optionally included in device 200 to provide instructions for operating I/O interface 204 and/or other components of device 200. For example, application 216 may include instructions for rendering a display of crowdfunding contributions by one or more users to a particular project or product, and for receiving input from a user of device 200 to submit a crowdfunding pledge for display via a crowdfunding platform.

Online store application 218 can be optionally included in device 200 to provide instructions for operating I/O interface 204 and/or other components of device 200. For example, application 218 may include instructions for rendering a display of a product or service for sale via an online webstore, for purchasing the product, and/or for listing a product for sale.

User activity collaboration application 220 can be optionally included in device 200 to provide instructions for operating I/O interface 204 and/or other components of device 200, in accordance with the present disclosure. For example, application 220 may include instructions for rendering a display of a UI provided by server 110 (via network communication interface 202). The UI may present a listing of projects for which users of system 100 can vote, pre-pledge crowdfunding contributions, view current point values for different types of user actions (e.g., social network post in a particular social network platform, crowdfunding contribution, online store purchase, etc.), time windows for bonus points (e.g., if user submits a social network post/crowdfunding contribution on a particular day and time, they can receive additional points, etc.), user-specific point multipliers, etc. Further, for example, the displayed data in the UI can be dynamically updated (e.g., point values, etc.) as other users perform user actions related to a particular project (e.g., point value of a crowdfunding contribution reduced if other users meet the target crowdfunding goal, etc.).

Alternatively or additionally, web browser application 222 can provide at least one or more of the functions described for applications 214, 216, 218, 220. In some implementations, web browser application 222 may condition content communicated via I/O interface 204 and/or network communication interface 202. For instance, web browser application 216 may include instructions for conditioning data communicated with any of servers 110, 112, 114, 116. Such data, for instance, may take the form of hypertext transfer protocol (HTTP) data packets and/or any other data format that web browser application 222 is configured to use for rendering a user interface (e.g., via I/O interface 204).

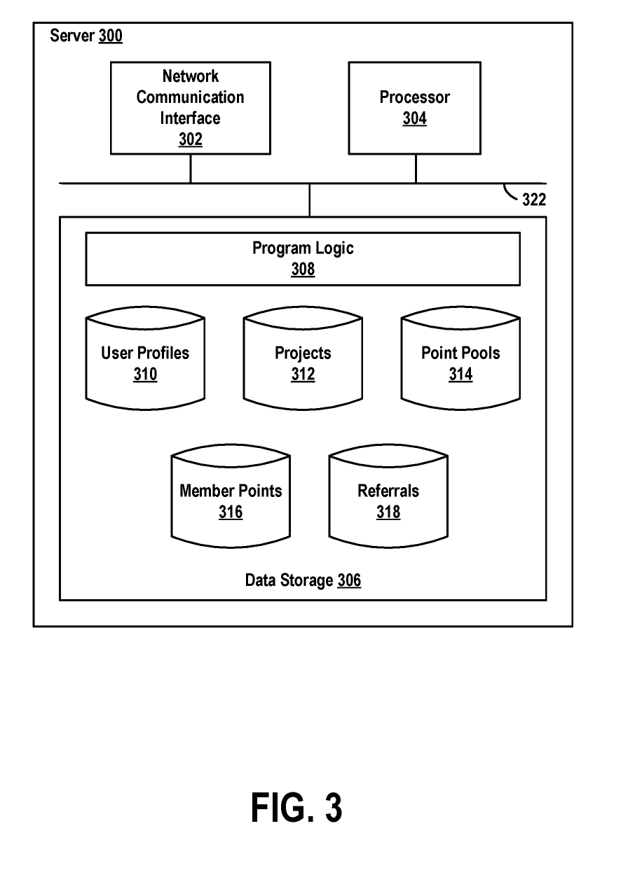

FIG. 3 is a simplified block diagram of a user activity collaboration server 300, according to an example embodiment. Server 300 may be similar to server 110, for example. It is noted that the various components and functional blocks in FIG. 3 are shown as part of one server device 300 for convenience in description. In some implementations, the various components shown may be distributed across multiple computing devices. Additionally, in some implementations, server 300 may include fewer or more components than those shown. It is also noted that the functional blocks in the various components of device 300 may be combined or separated into fewer or more blocks (e.g., software components, etc.). For example, server 300 can be physically implemented as multiple server devices, with each device performing some or all of the functions described for server 300.

As shown, server 300 includes a network communication interface 302, a processor 304, and data storage 306, all of which may be communicatively connected via a system bus, network, and/or any other connection mechanism 308.

Network communication interface 302 may include any combination of software and/or hardware components to facilitate communication between server 300 and one or more other network entities (e.g., other servers, user devices, etc.), similarly to interface 202. Processor 304 may be similar to processor 208, and may thus comprise one or more processors. Data storage 306 may include one or more volatile and/or non-volatile storage components (e.g., magnetic, optical, flash, organic storage, etc.), similarly to data storage 210. As shown, data storage 306 includes program logic 308, and stored data including user profiles 310, projects 312, point pools 314, member points 316, and referrals 318. Program logic 308 may take the form of machine language instructions or other logic executable or interpretable by processor 304 to carry out various functions and methods described herein.

Stored data 310, 312, 314, 316, 318 can be implemented as one or more databases or another data structure that allows server 300 to access and update various types of data. In one example, one or more of datasets 310, 312, 314, 316, 318 can be implemented as tables in a relational database that relates the tables to one another via indexes or other identifiers. However, other implementations are possible as well.

User Profiles dataset 310 comprises a plurality of user profiles identifying members of a community of users that can access server 300 to view information about projects, receive and view accumulated points, and/or other access other features of system 100. To that end, for example, dataset 310 may store user information such as any of: member ID, first name, last name, company name, email, address, phone number, phone type (e.g., mobile, landline, etc.), user-specific point multiplier (e.g., point level), referrer ID, and/or membership status.

The user-specific point multiplier (e.g., 1, 1.1, 1.2, 1.3, 1.4) may be a user-specific weight that server 300 applies to points earned by a particular user when the user performs a user action related to a project (e.g., submit a social network post in an external social network platform, submit a crowdfunding pledge in an external crowdfunding platform, purchase/sell a product associated with the project, etc.). To that end, the user-specific multiplier can be assigned to the user depending on various factors such as: the amount of time that the user was a member of the collaboration system of server 300, the level of activity of the user (e.g., number of previous social network, crowdfunding, etc., submissions, etc.), among other factors. Thus, program logic 308 may include instructions that cause server 300 to monitor user activity of users in dataset 310, such as, for example, user submissions published by crowdfunding server 112, social network server 114, and/or online store server 116. Further, program logic 308 may include instructions that cause server 300 to update a respective user-specific point multiplier of a user when the user reaches a certain activity milestone (e.g., number of submissions across multiple platforms, etc.).

The referrer ID may correspond to a member ID or other user profile identifier of another user (indicated in dataset 310) that referred a user to the system of server 300. In an example scenario, user A can access a user interface (e.g., via interface 204) provided by server 300 (e.g., via interface 302) to submit an invitation to potential new user B to join the community of server 300. Server 300 can then transmit a message (e.g., email, etc.) via interface 302 to user B indicating the invitation. If user B decides to join, server 300 can create a new user profile record in dataset 310 for user B, and include a referrer ID (e.g., member ID) of user A. Next, when user B performs a user action (e.g., social network post, etc.), server 300 can determine a point value for user B, and a reduced point value (e.g., 40%, etc.) for the referrer of user B (i.e., user A). To facilitate this, server 300 can access the referrer ID in dataset 310 to identify user A as a referrer of user B. Further, in some examples, if user A's record in dataset 310 includes a referrer ID of another user C (e.g., user C referred user A), then server 300 can assign another point value for user C as well (e.g., 10% of the point value received by user B, etc.). Through this process, for instance, a member can be rewarded for inviting additional community members every time the direct referral of the member or an indirect referral performs a user action.

In some implementations, dataset 310 may also include user identifiers that associate content submissions by a user in a third party electronic publishing platform. For example, the user identifiers may correspond to user credentials, social account names, or any other information that is published in a social network post or crowdfunding platform pledge by the user. In these implementations, server 300 can use the user identifier to filter content submissions (e.g., social network posts, etc.) by a member listed in dataset 310 from other content submissions from other users of the third-party electronic publishing platform. Alternatively, in some implementations, the email address stored in dataset 310 for a user can be the same email used in the third-party platform (e.g., social media account). In these implementations, server 300 can filter the published content submissions in the third-party platform using the email address stored in dataset 310.

Projects dataset 312 may comprise information related to active or past projects for which server 300 tracks and/or assigns point values to members in dataset 310. To that end dataset 312 may include project-related information such as any combination of: project ID, project title, project owner, start date, end date, project status, reverse royalty percentage, reverse royalty received, reverse royalty paid out, and/or affiliate commission rate.

For example, the start date and end date may correspond to time points between which members can receive points for participating in a project. The reverse royalty percentage may be a predefined percentage of a product or service sale value that is distributed by server 300 among users in dataset 310. In an example scenario, server 300 may provide a UI (e.g., via interface 302) for display at a user device (e.g., device 200) that allows the user (e.g., project owner) of the user device to create a new project (e.g., development of a new product or service for a start-up, expanding sales of an existing product or service, etc.). The project owner may then submit a reverse royalty percentage (e.g., 6%, etc.), which is a percentage of future sales of the product or service, to be distributed (at least in part) among community members (e.g., in dataset 310) depending on points accumulated (between the start date and end date) by the members and determined by server 300. Next, when sales occur, server 300 may update the “reverse royalty received” by the amount of the royalty payment, and then distribute the royalty payment among the users in dataset 310 depending on the accumulated points by each user at the time of royalty distribution.

Point pools dataset 314 can optionally be included in data storage 306 to define different types of points that can be accumulated by the users in dataset 310. In some implementations, a system of server 300 may be configured to maintain separate point pools for each type of user action tracked by server 300. In a first example, a “crowdfunding pool” can track points earned by users who participated in a crowdfunding campaign for a product by submitting crowdfunding contributions published by a crowdfunding platform (e.g., server 112). In a second example, a “branding pool” can track points earned by users who submit social network posts related to a project. In a third example, a “sales pool” can track points earned by users who purchase or sell products (e.g., via user's online webstore account).

In these examples, when a reverse royalty payment is received from a project owner, each pool may be assigned a predefined portion of the reverse royalty payment. As an example distribution, ⅓ of the reverse royalty payment may be assigned to the crowdfunding pool, ⅓ to branding pool, and ⅓ to sales pool. However, different distribution ratios or percentages are possible, and may in some instances be specific to a particular project. As an example, project A may have project-specific settings (e.g., stored in dataset 312, etc.) that indicate the royalty distribution scheme above. Whereas, in this example, project B may have different project-specific setting that indicate a royalty distribution scheme as follows: 40% for crowdfunding pool, 30% for branding pool, and 30% for sales pool. Other project-specific royalty distribution schemes are possible as well.

Regardless of the reverse royalty payment distribution scheme, a reverse royalty payment portion assigned to a particular pool can be distributed among users or members who submitted user actions for the particular pool and not to users who submitted actions for a different pool. Through this process, in some instances, points in the “crowdfunding pool” may correspond to a larger payment than points in the “branding pool” due to the limited amount of points available for the “crowdfunding pool” before the target crowdfunding amount is reached. However, other implementations are possible as well.

In some implementations, server 300 may also allocate a one-time bonus payment, which may be referred to herein as a “momentum bounce,” for users who participate in a crowdfunding campaign that exceeds a predefined crowdfunding goal. For example, if the target crowdfunding goal of a project is $30,000 and the sum of crowdfunding pledges published by a crowdfunding platform is greater than $30,000, then community members (e.g., listed in dataset 310) who submitted crowdfunding pledges may receive a one-time bonus payment (“momentum bounce”) that can be, for example, a predefined percentage (e.g., 5%, etc.) of crowdfunding funds raised beyond the target $30,000.

Dataset 314 may store data such as any combination of: pool ID, pool type (e.g., crowdfunding, branding, sales, etc.), project ID (e.g., the associated project ID in dataset 312), open date, close date, time window for point value 1, point value 1 (PV1), time window for point value 2, point value 2 (PV2), etc. The open date and close date can be parameters that an administrator-type user can enter via an administrator UI provided by server 300 for display at a user device of an administrator user. For instance, each pool can have a limited time period in which users can earn points (e.g., crowdfunding pool may provide points to users who pledge amounts in the crowdfunding platform during the first day, two days, etc.). Further, the administrator and/or project owner may set a different point value during different time windows in which user actions are detected. For instance, social network posts detected during the first hour after project launch may be rewarded a higher point value than social network posts detected during the second hour after project launch. As such, server 300 can assign an appropriate weight to point values awarded depending on how timely users contribute to a crowdfunding campaign, social marketing campaign, etc.

Member points dataset 316 may store data (e.g., user activity data) indicating weighted point values awarded to users who submit content published by a crowdfunding platform, social network platform, etc. To that end, dataset 316 may store any combination of: activity ID, activity type (e.g., crowdfunding contribution, social media post, referral points, etc.), pool ID (e.g., mapped to dataset 314), member ID (e.g., mapped to dataset 310), points earned/weighted point value, activity performer ID, activity performer relationship, submission time or activity time, etc.

The points earned may be a dynamically weighted point value that is determined for the submission time of a social network post, crowdfunding pledge, product sale or purchase, etc. As noted above, the points earned for an activity or content submission may vary depending on the submission time among other factors.

In a first example, a base point value for a user action detected that corresponds to a particular pool may vary over time (e.g., PV1, PV2, etc.).

In a second example, a user-specific weight or multiplier (e.g., point level, etc.), stored in dataset 310, can be applied to the base point value depending on the current point level of the user at the submission time. The user-specific weight may increase over time as the user reaches certain activity level milestone. For example, a level one user may be a signed a user-specific weight of 1.1 until he contributes X number of social network posts, crowdfunding contributions, etc. in one or more project listed in dataset 312. Once the X number of content submissions is reached, the user-specific weight may be increased to 1.2, etc. Alternatively or additionally, a user can attain the next activity level milestone by referring a predefined number of new users to the system of server 300, among other possibilities. In some implementations, the user-specific weight can optionally decrease over time as well if the user fails to perform certain user actions. For instance, if the user pre-pledges or commits to a certain crowdfunding contribution and server 300 does not detect the pre-pledged contribution in the actual pledged amounts published by the crowdfunding platform within a predefined crowdfunding time window, then the user-specific multiplier of the user can be reduced (e.g., level 2 user becomes level 1 user, etc.).

In a third example, the points earned can be weighted depending on a number of content submissions detected prior to a particular content submission. For instance, if a user submits a social network post related to the project after one hundred prior social network posts were detected, the point value awarded for the post may be weighted to be less than that awarded to the previous posts.

In a fourth example, the points earned can be weighted depending on the currently pledged crowdfunding amounts at the submission time. For instance, if the sum of crowdfunding pledges published by a crowdfunding platform is within a first range (e.g., $0-$10,000), then a crowdfunding pledge at that submission time may have a higher weight than at a submission time when the sum of crowdfunding pledges is within a second range (e.g., $10,001-$20,000).

In a fifth example, a point value awarded to a user for an activity performed by a direct referral may be weighted higher than a point value awarded to the user for an activity performed by an indirect referral. For instance, consider a scenario where user A referred user B who referred user C to the collaboration system of server 300. In this scenario, when server 300 detects an activity performed by user C (e.g., submission of a crowdfunding pledge, social network post, etc.), then server 300 may award user C a certain point value, user B a weighted point value that is a percentage of that awarded to user C (direct referral), and user A a further weighted point value that is a lower percentage than that awarded to user C (indirect referral).

To that end, the activity performer ID may correspond to the member ID if the member is the one who performed the activity, or may correspond to a referral member ID if a referral member was the member who actually performed the activity.

In line with the discussion above, server 300 may be configured to dynamically weight the point value awarded for each user action or activity published by any of crowdfunding server 112, social network server(s) 114, online store server(s) 116, etc., based on the submission time or occurrence time of the activity, among other factors. Further, the user activities may occur frequently (e.g., hundreds, thousands, or more actions within seconds, etc.) and the weight applied to the point values can dynamically change for each detected activity. Through this process, for instance, since server 300 may be configured to compute and store each dynamically weighted point value, the users may be motivated to perform as many user actions as possible in a timely fashion. As a result, for instance, the system of server 300 may increase the likelihood of achieving high online presence momentum in a coordinated manner between multiple platforms to improve the chance of the project to have a successful launch. For instance, users can be awarded higher weight point values for both social network submissions and crowdfunding submissions during the same or proximal time windows to increase the likelihood that other public viewers of the crowdfunding platform and/or the social network platform may notice the project and join the crowdfunding campaign or purchase the product.

Referrals dataset 318 may store data indicating the level of member influence or referrals of users listed in dataset 310. By doing so, for instance, server 300 can compute referral point values in a quick and efficient manner to updated dataset 316 even as hundreds, thousands, or more user actions are detected over multiple electronic publishing platforms (e.g., social network platform A, social network platform B, crowdfunding platform, online store platform, etc.) in a short period of time. To that end, dataset 318 may include any combination of: member ID (e.g., mapped to dataset 310), referrer (e.g., user who referred the member to the system), direct referral (e.g., user who was referred to system by the member), indirect referral level 1 (e.g., a direct referral of a user who is a direct referral of the member), indirect referral level 2 (e.g., a direct referral of a user who is an indirect referral of the member), etc.

With this implementation, for instance, server 300 can optionally limit the number of degrees of separation between a member who receives referral point values and a performing member who actually performs the user action. In an example scenario, dataset 318 can store, for a given member, only the indirect referrals who are separated from the given member by no more than 2 other members. For instance, if user A refers user B who refers user C who refers user D who refers user E, then dataset 318 may store, in a record for user A, the member IDs of user B (direct referral), user C (indirect referral level 1), and user D (indirect referral level 2), but not user E who is separated from user A by more than 2 members. However, other scenarios are possible.

In one example, the computing device can store relationship information between users in a tree data structure. As such, a given node in the tree may correspond to a given user, and each child node of the given node may correspond users referred to the system of server 300 by the given user. As such, when an event (e.g., content submission) is detected, server 300 can traverse the tree data structure quickly to determine and update point values for referring users. For example, the user associated with the event may correspond to a particular “child” node C1 in the tree structure. A parent node P1 of the child node C1 may correspond to a user who was a direct referrer (e.g., “direct influencer”) who referred the child node user to the system of server 300, and may thus be assigned a particular referrer weight (e.g., P1 weight) that is applied to a determined point value awarded to the child node. Additionally, grandparent node G1, which is the parent node of node P1, may be a first-level indirect influencer, and may be assigned to a G1 weight which is less than the P1 weight. Similarly, higher level grandparent nodes (e.g., G2, G3, . . . , G7, etc.) can receive gradually decreasing respective weights.

In one embodiment, the system can limit who receives point value awards for a single user action of child node C1 to users within nine levels of influence (e.g., C1, P1, G1, G2, . . . , G7). In other embodiments, the system may award points to any number of referring users without influence level limitations, or with a different influence level limitation than nine levels. Additionally or alternatively, the number of influence levels can be project-specific and/or time-dependent. For example, project A can be predetermined (e.g., set by project owner or administrator, etc.) to award partial point values to users within nine levels of influence from a child node, and project B may be predetermined to award users within just 5 levels. As another example, the number of influence levels assigned to project A can change over time as project A achieves certain milestones (e.g., crowdfunding goal reached, etc.). As such, project-specific and/or time-dependent rules with respect to referral point awards can also add a further layer of complexities in the point value weight calculation

Thus, with this implementation, server 300 can efficiently and quickly compute and update point values for referring users while monitoring multiple electronic publishing platforms simultaneously, and detecting hundreds, thousands, or more user actions in a short period of time. Further, this feature would not be possible in conventional systems, but is possible in the implementation of server 300 at least because datasets 310, 312, 314, 316, and 318 are stored and accessible from a single location. For example, server 300 can determine a time-dependent and history-dependent dynamically weighted point value for storage in dataset 316 each time server 300 detects a content submission in one of multiple electronic publishing platforms by accessing, efficiently and quickly, user profile dataset 310 (e.g., to match a detected submission with a user), project dataset 312 (e.g., to obtain weighting rules specific to a project), points pool data (e.g., to obtain weighting rules specific to a pool), and referrals dataset 318 (e.g., to obtain a listing of parent and grandparent referring users for this particular submission, and to award points to those users according to predefined weights). Whereas, for example, a conventional system might only monitor a single social network platform server separately, and may thus be unable to adjust point value weights based on user referral relationships, other content submissions in other platforms, the status of the project in a remote platform, among other factors.

Through this process, for instance, when a royalty payment event is detected (e.g., product sale occurs, quarterly report from project owner received, etc.), the sum of weighted point values awarded to each user prior to the royalty distribution time can be computed accurately. In an example scenario, a reverse royalty payment amount indicated at time X for project Y may be $10,000. Server 300 may then determine that 30% of that amount (e.g., $3,000) should be distributed among users in the “crowdfunding pool” of project Y, who pledged crowdfunding amounts during the crowdfunding time window, before the crowdfunding target sum (e.g., $30,000) was reached, and before time X. Server 300 may then compute a first sum of weighted point values (stored in dataset 316) in the crowdfunding pool of project Y that were earned by user A and meet these conditions. Server 300 may also compute a second sum of all weighted point values in the crowdfunding pool of project Y earned by all users. Server 300 may then provide a portion of the $3,000 to user A based on a ratio of the first sum and the second sum. For example, if the first sum is 10 points and the second sum is 100 points, then an account of user A could be credited by 10/100*$3,000=$300. Other scenarios and royalty payment distribution criteria are possible as well.

It is noted that functional blocks of FIG. 3 are illustrated for convenience in description and are not meant to be limiting. In some examples, server 300 may be implemented using more or fewer components than those shown. In one example, the functions described for datasets 310, 312, 314, 316, 318 can be implemented in one, two, or more databases. In another example, any of datasets 310, 312, 314, 316, 318 could be alternatively stored within several devices and/or servers. In yet another example, some of the functions described above for server 300 can be alternatively implemented by a user device (e.g., devices 102, 104, 106, 200, etc.).

### IV. Example Methods and Computer Readable Media

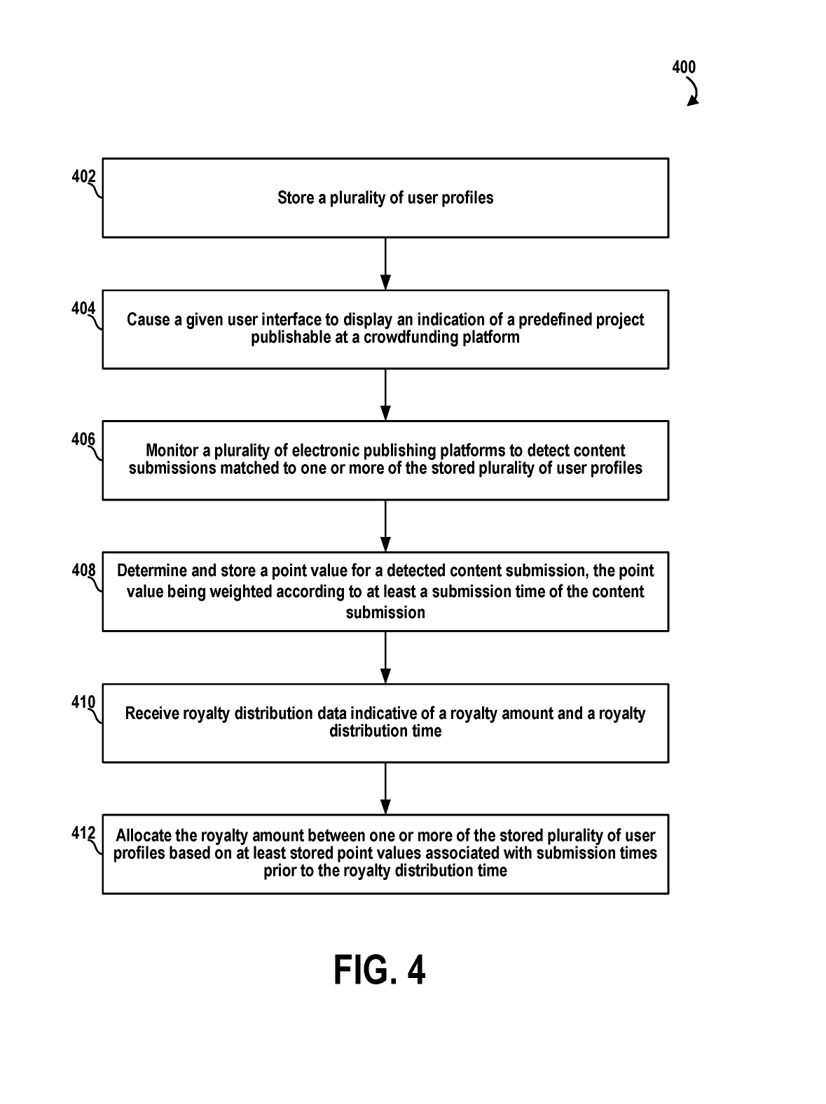

FIG. 4 is a flowchart of a method 400, according to an example embodiment. Method 400 shown in FIG. 4 presents an embodiment of a method that could be used with system 100, device 200, and/or server 300, for example. Method 400 may include one or more operations, functions, or actions as illustrated by one or more of blocks 402-412. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

Additionally, for method 400 and other processes and methods disclosed herein, the flowchart shows functionality and operation of one possible implementation of present embodiments. In this regard, each block may represent a module, a segment, a portion of a manufacturing or operation process, or a portion of program code, which includes one or more instructions executable by a processor for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage device. In some examples, for method 400 and other processes and methods disclosed herein, each block may represent circuitry that is wired to perform the specific logical functions in the process.

At block 402, method 400 involves a computing system storing a plurality of user profiles. For example, server 300 may store user profiles 310 for a plurality of users. A given user profile may include user credentials, such as emails, usernames, or other user identifiers, that identify content submissions by a given user that are published by at least one of a plurality of electronic publishing platforms including crowdfunding platform(s) and social networking platform(s). By way of example, members of an online community may sign up at a website interface of a computing system (e.g., system 100) to receive data about a project for launching a new product or increasing sales of an existing product. Further, each member may submit user credentials, such as social account names or email addresses, that the member uses to access social media accounts, crowdfunding platform user account, online store user account, etc. The user credentials, for instance, may correspond to a social account name, tag, etc., of the user that a particular social network uses to publish content submitted by the user via a social network account of the user.

In some implementations, storing the plurality of user profiles at block 402 may comprise storing the plurality of user profiles mapped to user activity data pertaining to a predetermined product or service. For example, each record in member points dataset 316 (user activity data) may include a reference (e.g., member ID) that maps the record to a user profile of user profiles dataset 310.

At block 404, method 400 involves causing a given user interface (UI) to display an indication of one or more predefined projects publishable at a crowdfunding platform. In an example scenario, a member of the online community (e.g., user associated with one of the plurality of user profiles stored at block 402) may access a website or the given user interface (e.g., via communication interface 202 and I/O interface 204, etc.) hosted by a user activity collaboration server (e.g., servers 110, 300, etc.). The website may include a software dashboard, for instance, that displays a listing of projects related to development of a product or service. A first example project may be associated with a new product that a project owner wants to raise capital for using a crowdfunding platform. A second project, for instance, may be associated with a service (e.g., lawn mowing business, etc.) that a project owner wants to market in a new town. Other example projects are possible.

In some instances, the UI displayed to the member may also include an input interface for receiving a vote or pre-pledge for supporting a particular online publishable activity related to the project. In one instance, the member can indicate that he votes for pledging a particular crowdfunding amount if the project is launched on a particular crowdfunding platform. In another instance, the member can indicate that she will purchase a particular number of units of a product that will be developed by the project owner as part of the project. In yet another instance, the member can indicate that she will list the product on her user-managed online store. In still another instance, a member can indicate that she will publish a referral link for an online store portal that lists the product.

In these instances, method 400 may also involve determining that a threshold number of votes or pre-pledges are indicated in inputs received from UIs associated with the plurality of user profiles, and responsively causing a crowdfunding server to publish the project. For example, when a sufficient number of users pre-pledges to contribute a threshold sum of crowdfunding amounts, purchase a threshold number units of a product, or submit a threshold number of social network posts, server 110 may then establish a connection with crowdfunding server 112 to release or submit a new crowdfunding project. In some examples, server 110 may also send a notification (e.g., message, email, text displayed on UIs provided to user devices, etc.) to users that voted or pre-pledged to contribute to the project along with one or more time windows for the users to complete the pre-pledges in order to receive reward points or bonus reward points.

In other instances, the UI displayed to the member may include an indication of a plurality of electronic publishing platforms (e.g., social network platform A, social network platform B, crowdfunding platform C, online store platform D, etc.), in which the viewing member can submit content to receive point values. Further, in these instances, the UI may also display point values, time windows, point multipliers, and other dynamic point weighting criteria. Further, in some instances, the UI may also include links or data feeds that display data from the various publishing platforms related to the project in a single view. In these instances, the viewing member can access the various platforms efficiently to submit content (e.g., social network posts, etc.) using their respective accounts at these platforms. To facilitate this, for instance, server 300 may access the various third-party platforms using user credentials stored for the viewing user in dataset 310. To that end, server 300 may also include application programming interfaces (APIs) for accessing and/or conditioning the data obtained from the various platforms for display via the given UI at a user device of the viewing member.

At block 406, method 400 involves monitoring a plurality of electronic publishing platforms to detect content submissions matched to one or more of the stored plurality of user profiles. In a first example, server 300 may repeatedly download aggregated content (e.g., in a website) published by crowdfunding server 112 for one or more projects in which members of the community (e.g., indicated in the stored plurality of user profiles) could submit pledges to receive reward points. In some instances, the downloaded aggregated content may comprise data having a specific format associated with the crowd funding platform (e.g., comma separated file, CSV, etc.). In a second example, server 300 may activate an API or monitor email notifications from crowdfunding server 112 to identify pledges submitted by users of the computing system. In a third example, server 300 may download aggregated content published by a social networking platform (and/or activate an API thereof) to similarly detect social network posts published for users in one or more of the plurality of user profiles.

In some implementations, the monitoring at block 406 may involve detecting an update to aggregated content (e.g., social network post stream, crowdfunding pledge listing, etc.) published by an electronic publishing platform. The update may pertain to a given content submission being aggregated with other content submissions previously included in the aggregated content. In these implementations, method 400 may also involve assigning a submission time for the detected content submission based on a time of detection of the update.

In other implementations, method 400 may involve determining the submission time of the detected content submission based on data included in the aggregated content. For example, a social networking platform may include a timestamp with each social network post or content submission in the aggregated content. To that end, server 300 may extract the timestamp by parsing the aggregated content, and then use the extracted timestamp as the submission time of the detected content submission.

In a third example, server 300 may monitor social network posts that include a tag or a name of a product associated with the project. For instance, the given UI provided at block 404 may include a listing of tags or keywords that the users should incorporate in social network posts they submit at a social networking platform that operates server 114 using their social network accounts. Thus, in some implementations the monitoring at block 406 may comprise monitoring a crowdfunding platform and a social networking platform to detect content submissions that include content related to a predetermined product or service.

In this example, server 300 may receive a feed of published social network posts or may download published social network posts from server 114 to identify and/or filter content submissions by users of the system. In still another example, similarly, server 300 may obtain published updates from online store server 116 for purchases of a product associated with a monitored project (e.g., listed in dataset 312), or monitor sales of the product through one or more user webstores (e.g., Amazon® or eBay® user account, etc.). To facilitate this, server 300 may compare user credentials (e.g., social account name, crowdfunding account user name, email address, etc.) stored in user profiles dataset 310 to user credentials combined and/or otherwise associated with published content submissions at servers 112, 114, and/or 116. Accordingly, in some implementations, the monitoring at block 406 may comprise monitoring the crowdfunding platform and the social networking platform to detect content submissions that match respective user credentials (and/or other user identifiers) in the plurality of user profiles.

Thus, in some implementations, method 400 may involve monitoring, via a data communication network (e.g., network 108), aggregated content (e.g., social network post stream, crowdfunding contributor listing, etc.) related to a predetermined product or service (e.g., the product or service related to the project publishable in the crowdfunding platform). The aggregated content may be dynamically updated and published by an electronic publishing platform (e.g., social network platform, crowdfunding platform, etc.) that aggregates user-submitted content (e.g., crowdfunding pledges, social network posts, etc.) together with user identifiers for the user-submitted content.

In these implementations, method 400 may also involve filtering, from the aggregated content, a plurality of content submissions having respective user identifiers corresponding to at least one of the stored plurality of user profiles. For example, server 300 may receive aggregated content (e.g., listing of crowdfunding pledgers) published by a crowdfunding platform of server 112. In this example, server 300 may then filter the aggregated content to extract crowdfunding pledges that were submitted by users who have a user profile in the plurality of user profiles stored at block 402.

Thus, in some implementations, based on the monitoring at block 406, method 400 may also involve detecting a content submission: (i) published by one of the plurality of electronic publishing platforms, (ii) identifying the user credentials in a given user profile of the plurality of user profiles, and (iii) including content referencing a particular product or service (e.g., associated with a project in dataset 312).

At block 408, method 400 involves determining and storing (e.g., user activity data stored in dataset 316) a point value for a detected content submission. The point value may be weighted or otherwise determined according to at least a submission time of the detected content submission. By way of example, in response to detecting a content submission matching a stored user profile, server 300 may determine a point value for the matched user profile according to various factors.

In some examples, the determined point value may depend on the submission time of the detected content submission. In a first example, a crowdfunding pledge submitted within a predefined time window may receive a higher point value than a crowdfunding pledge submitted within a later time window. For instance, a crowdfunding pledge submitted in the first hour, 6 hours, 24 hours, or any other predefined first time window can receive a higher point value than a crowdfunding pledge submitted in a second (later time window).

In a second example, a social network post submitted after a hundred previous social network posts were submitted may receive a higher point value than a social network post submitted after a thousand previous social network posts were submitted.

In a third example, a product purchase submitted by a user who is a legacy member (e.g., member for more than three years, member who had a high level of activity in the past week, etc.) can receive a point value weighted by a higher user-specific weight or multiplier than a product purchase by a user who is less involved with projects in the system (e.g., member for less than three years, member who had a low level of activity in the past week, etc.). Accordingly, in some implementations, method 400 also involves determining, for a given user profile, a user-specific point multiplier based on at least (i) a number of content submissions mapped to the given user profile, storing an indication of the user-specific point multiplier (e.g., in dataset 310), and determining the point value at block 408 based on the user-specific point multiplier if the detected content submission is matched to the given user profile.

In a fourth example, a crowdfunding pledge submitted prior to a crowdfunding milestone is reached may receive a higher weight than a crowdfunding pledge submitted after the crowdfunding milestone is reached. In one implementation, if the sum of all crowdfunding pledges published is less than $10,000 at the submission time of a detected pledge, then a high point value may be awarded to the user for the pledge. Whereas, in this implementation, if the sum was greater than $10,000 a lower point value may be awarded to the user. Other examples are possible.

Accordingly, in some implementations, method 400 may also involve determining the point value at block 408 based also on a sum of pledged amounts published by the crowdfunding platform prior to the submission time of the detected content submission.

In a fifth example, a social network post that receives responses (e.g., from the public or from members listed in data set 310), may receive additional point values. For instance, a social network post by a member that receives multiple responses may be more noticeable than one that does not receive any social network interactions from the public. Further, in some instances, server 300 can further weight the response based on its submission time. For instance, social network responses detected earlier during a social network marketing campaign (or while a crowdfunding campaign is still active) may award a user higher point values than one received a year later. Thus, in some implementations, method 400 also involves identifying a social network response to the detected content submission, and responsively determining and storing a second point value, for the user profile associated with the detected content submission, based on at least a response submission time of the social network response.

In some implementations, method 400 also involves causing the given UI to display an indication of a start time for monitoring aggregated content (e.g., listing of crowdfunding pledges, social network post stream, etc.) published by an electronic publishing platform (e.g., crowdfunding platform, social networking platform, etc.). In these implementations, determining the point value at block 408 may be also based on a difference between the start time and the submission time of the detected content submission. For example, the determined point value for a crowdfunding pledge can be dynamically weighted by a lesser weight as time passes from the start time when the crowdfunding project was launched on the crowdfunding platform.

In some examples, the determined point value may also depend on the identity of the user who submitted the detected content submission. For example, a first member who submitted the content submission may receive a higher point value than a second member who referred the first member (e.g., direct referral) to the system of method 400. Further, a third member who referred the second member (e.g., indirect referral) may receive a further reduced point value compared to the first member and the second member.

In some implementations, method 400 also involves causing the given UI to display an indication of downloadable media content related to a predetermined product or service (e.g., project listed in dataset 312). In these implementations, method 400 also involves determining whether the detected content submission includes the downloadable media content, and determined the point value at block 408 based on whether the detected content submission includes the downloadable media content. For example, the given UI may display a download link to a particular image or banner that promotes the project, product, and/or service. As such, the system may award bonus points or higher weighted point values to users that incorporate the downloadable image into the social network posts they submit using their social network accounts. Through this process, for instance, social network users viewing the image multiple times may begin to associate the image with the product, which may assist the project owner in building a recognizable brand for the product. In turn, the system may reward users who provide this type of social network contribution by awarding additional points or applying a higher weight for point values that are awarded for social network posts that incorporate the uniform downloadable media content. Further, in some examples, the bonus weight, multiplier, or point values for the media content may vary over time depending on how many users have already incorporated that particular media content into previously detected content submissions.

In some implementations, method 400 also involves providing a user-specific referral link via the given UI. For example, the user-specific-referral link may link a viewer to a online store portal that lists the predetermined product or service. Thus, for example, if a user posts the referral link to the public (via social networking platform, etc.). The user can receive a weighted point value in the sales pool if a customer purchases the product or service using the user-specific referral link (e.g., hyperlink, etc.).

At block 410, method 400 involves receiving royalty distribution data indicative of a royalty amount and a distribution time. In one example, the royalty distribution data may correspond to a message received from a remote server (e.g., server 116) every time a sale of a product or service related to the project occurs. In another example, the royalty distribution data may correspond to a communication received (e.g., via interface 302) from a project owner based on sales (e.g., quarterly, etc.) of the product or service. In yet another example, the royalty distribution data may correspond to a communication received from a distributor (e.g., batch sale distributor) or affiliate that sells the product or service. In still another example, the royalty distribution data may correspond to an input (e.g., data upload) received from an administrator user via and administrator UI (e.g., graphical user interface) provided to the administrator user. In this example, the input data may be provided based on a collection of sales data uploaded to the system of method 400 by the administrator user. Other examples are possible.

Accordingly, in some implementations, method 400 also involves detecting a royalty distribution event (e.g., sale of a unit, receipt of input, received of message, etc.) related to a sale of a predetermined product or service (e.g., related to a project listed in dataset 312) and indicative of the royalty amount and the distribution time. To that end, for example, the distribution time can be determined by server 300 based on a time of receipt of the royalty distribution message, an input distribution time (e.g., by an administrator), a recorded time of a sale of a product, and/or the distribution time may be incorporated in the royalty distribution message, among other possibilities.

In line with the discussion above, a system of the present disclosure can dynamically weight reward point values based on a multitude of varying time-dependent weights. Through this process, for instance, users of the system can be motivated to, in a timely and a coordinated fashion, contribute to building early public momentum for a successful product launch. The complex and frequent calculations involved as well as the potentially simultaneous and frequent royalty distribution events may pose a technical challenge for maintaining accurate results that motivate the users of the system to participate. As noted above, the present system overcomes these technical challenges by storing and dynamically updating the various types of data in datasets 310, 312, 314,316, 318, by monitoring updates that occur in multiple electronic publishing platforms (e.g., social network platforms, crowdfunding platforms, online store platforms, etc.) simultaneously, and by providing a compact view of the dynamically updated data (e.g., point values, weights, multipliers, projects, etc.) to members of the system, among other features of the present disclosure.

At block 412, method 400 involves allocating the royalty amount between one or more of the stored plurality of user profiles based on stored point values (e.g., user activity data) having submission times prior to the royalty distribution time. For example, server 300 may extract entries in dataset 316 for activities performed prior to the royalty distribution time in relation to a particular project for which the royalty amount was received. Next, server 300 may compute, for a user profile, a first sum of weighted point values in the extracted entries. In this example, server 300 may also compute a second sum of weighted point values in the extracted entries for all user profiles. Further, in this example, the server 300 may allocate, for the user profile, a portion of the royalty amount based on a ratio of the first sum and the second sum.

In other examples, the first sum and the second sum can be computed only for activities associated with a particular pool of the point pools in dataset 314. For example, crowdfunding activities in the “crowdfunding pool” of points can have a separate royalty allocation calculation from social networking activities in the “branding pool.” Through this process, for instance, the amount of reverse royalty paid for each point may also differ depending on the pool or the type of activity (e.g., crowdfunders may receive a higher payment per point than branders, etc.).

Thus, in some implementations, method 400 also involves determining respective point balances of the plurality of user profiles based on stored point values in user activity data (e.g., datasets 314, 316, etc.), and allocating a portion of the royalty amount to a user profile based on a ratio of the determined point balance of the user profile to a sum of point balances of the plurality of user profiles. Further, in some implementations, method 400 may also involve causing the given UI to display an indication of the allocated portion of the royalty amount.

It is also noted that the ordered combination of functions in some examples herein (e.g., monitoring multiple electronic platforms, detecting content submissions matched to the stored plurality of user profiles, determining point values based on at least submission times of the detected content submissions, and allocating royalty payments among a plurality of user profiles based on the stored point values, etc.) is unique and necessary to achieve a distribution of the royalty payment in a meaningful way.

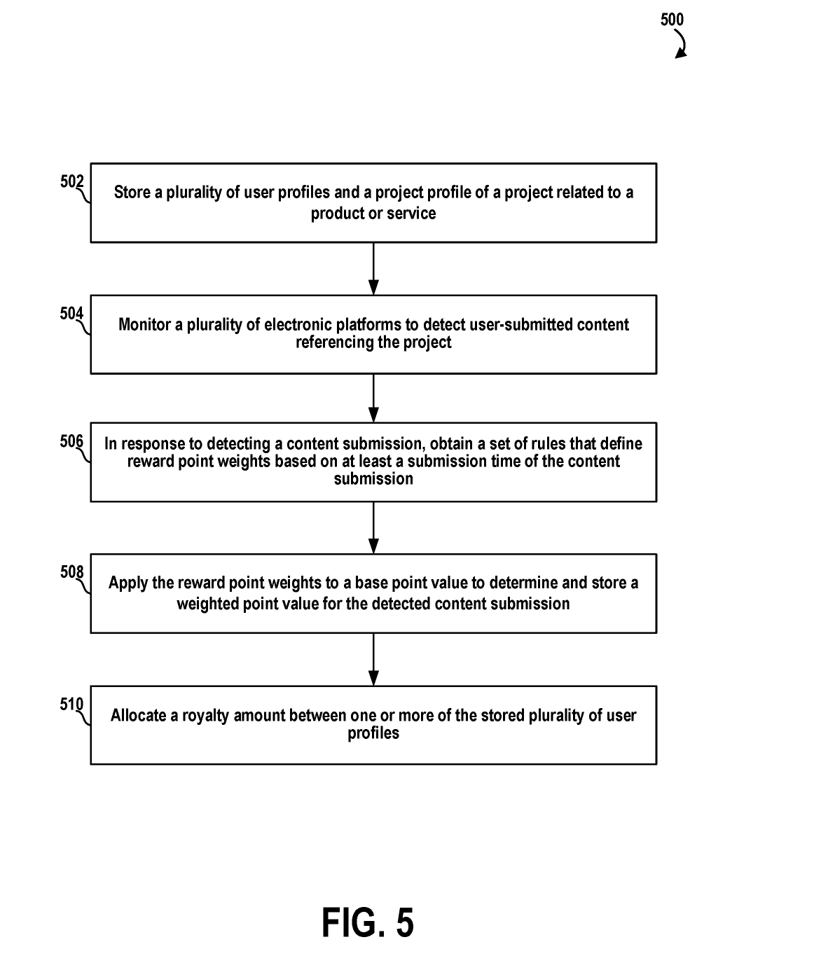

FIG. 5 is a flowchart of another method 500, according to an example embodiment. Method 500 shown in FIG. 5 presents an embodiment of a method that could be used with system 100, device 200, and/or server 300, for example. Method 500 may include one or more operations, functions, or actions as illustrated by one or more of blocks 502-510. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation.

At block 502, method 500 involves storing a plurality of user profiles (similarly to block 402), and a project profile of a project related to a product or service. For example, server 300 can store user profiles dataset 310 that includes user credentials (e.g., social network account user names, crowdfunding account usernames, emails, etc.) that are used to identify content submissions of the users at electronic publishing platforms that publish the content submissions (e.g., social network posts, crowdfunding pledges, etc.). Further, the project profile may indicate a particular project assigned for promotion through multiple electronic publishing platforms by the users (of the user profiles) submitting social network posts, crowdfunding pledges, etc. using their user accounts.

At block 504, method 500 involves monitoring a plurality of electronic platforms to detect user-submitted content referencing the project, similarly to block 406 for example. To that end, an example system can include software interface components that are specifically designed to extract published data (e.g., dynamically updated websites) formatted according to particular electronic publishing platform. Thus, the present method may overcome a technical challenge faced by conventional systems that do not store such related data in a single location. For instance, the example system can track and monitor user activity (referencing the project of the project profile) in social network platforms A, B, C, crowdfunding platform D, and/or online stores E, F, G simultaneously and efficiently. The system can also quickly filter aggregated content that includes submissions by other users and store weighted point values just for the users of the user profiles in the stored plurality of user profiles.

At block 506, method 500 involves, response to detecting a content submission, obtaining a set of rules that define reward point weights as a function of a submission time of the detected content submission.

In a first example, project A (of the stored project profile) may have a rule that specifies a particular point value (PV1) for crowdfunding pledges submitted between time t1 and t2, and a different point value (PV2) for crowdfunding pledges submitted between time t2 and t3. In a second example, the set of rules may include a rule for applying a user-specific weight or multiplier that is specific to the user profile of the user who submitted the content submission. In a third example, project-specific weights may depend on the electronic publishing platform (e.g., social networking platform A may have different weight than social networking platform B). In a fifth example, a weight can be based on a number of content submissions previously detected in one or more electronic publishing platforms (e.g., including a sum of social network posts in platforms A, B, and C prior to detection of the current submission). In a sixth example, a weight can depend on a difference between a predefined crowdfunding goal and a current crowdfunding goal. Other weights are possible as well such as any combination of weights in the description of server 300 and method 400.

At block 508, method 500 involves applying the reward point weights to a base point value (e.g., PV1, PV2, etc.) to determine and store a weighted point value for the detected content submission. For example, a system of method 500 can determine a weighted point value for each detected content submission (e.g., social network post, crowdfunding pledge, etc.) based on a variety of time-dependent factors and weights according to the following equation:

DPV=PVₓ*W₁* . . . *Wₙ

where DPV is the determined point value for a content submission, PVx is the time-dependent (and/or pool-dependent) point value for this type of content submission (e.g., PV1, PV2, etc.), and [W₁, . . . , Wₙ] includes a set of weights that can be: user-specific (and thus varies over time depending on user activity history, etc.), project-specific (e.g., remaining amount to reach predefined crowdfunding goal, bonus weight for submitting a social network post during the first few hours from launching a product, etc.), among other possibilities. Further, the set of weights can differ over time. For example, a project-specific (e.g., bonus weight) can be applied only during a time window, and removed from [W₁, . . . , Wₙ] if the content submission has a submission time outside that time window.

At block 510, method 500 involves allocating a royalty amount between one or more of the stored plurality of profiles, similarly to block 412 for example.

It is noted that conventional techniques such as a human operator looking for social network posts in a single social network platform for a product, to subjectively select a user for reward points may not be a reliable way to reward users in a way that motivates them to achieve high momentum for a product launch. Whereas, the present method provides a technical solution based on specific rules by applying time-varying weights to calculate reward points based on a number of factors. This solution was not known prior to the present method and would not be possible without the technological improvements that result from the particular arrangement of elements in the present method. Thus, for example, the present method incorporates elements that, when viewed as a combination, operate in a non-conventional and non-generic way to ensure that the royalty payment allocation is more accurate and rewarding for users who submit content in a timely and early manner relative to other users. As a result, users may be motivated to establish an online presence momentum for the project to receive the highly weighted points during early launch.

Additionally, it would be impossible for a human operator to perform this method. For example, this method involves monitoring multiple electronic publishing platforms simultaneously, and determining time-sensitive reward point values for each user depending on user activities in the multiple platforms. As noted above, in some examples, hundreds, thousands, or more social network posts, crowdfunding pledges, online sales, etc., may occur within a short period of time (e.g., seconds, minutes, etc.). And, in these examples, the respective weighted point values for each of these events may depend on previous events and affect the weighted point values of subsequent events.

It should be understood that arrangements described herein are for purposes of example only. As such, those skilled in the art will appreciate that other arrangements and elements (e.g. machines, interfaces, functions, orders, and groupings of functions, etc.) can be used instead, and some elements may be omitted according to the desired results. Further, many of the elements that are described are functional entities that may be implemented as discrete or distributed components or in conjunction with other components, in any suitable combination and location, or other structural elements described as independent structures may be combined. While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
a computing system storing, in data storage, a plurality of user profiles, wherein a given user profile includes user credentials that identify content submissions by a given user at a plurality of electronic publishing platforms including a crowdfunding platform and a social networking platform;
causing a given user interface for the given user profile to display: (i) an indication of a predefined project publishable at the crowdfunding platform, the predefined project being related to development of a particular product or service, and (ii) an indication of the plurality of electronic publishing platforms that the computing system tracks for user-submitted content related to the predefined project;
monitoring, via a data communication network, the plurality of electronic publishing platforms to detect content submissions that match respective user credentials in the stored plurality of user profiles;
based on the monitoring, detecting a content submission: (i) published by one of the plurality of electronic publishing platforms, (ii) identifying the user credentials in the given user profile, and (iii) including content referencing the particular product or service;
responsive to the detection, determining a point value for the content submission, the point value being weighted according to at least a submission time of the content submission;
storing, in the data storage, user activity data indicating the determined point value, the submission time, and a mapping of the determined point value to the given user profile;
receiving a royalty distribution message (i) related to a sale of the particular product or service and (ii) indicative of a royalty amount and a distribution time;
based on at least point values, in the user activity data, associated with submission times prior to the distribution time, allocating the royalty amount between one or more of the plurality of user profiles; and
causing the given user interface to display an indication of a portion of the royalty amount allocated to the given user profile.

2. A method comprising:
a server storing, in data storage, a plurality of user profiles, wherein a given user profile includes user credentials that identify content submissions by a given user at a crowdfunding platform and a social networking platform;
monitoring, via a data communication network, the crowdfunding platform and the social networking platform to detect content submissions that (i) match respective user credentials in the stored plurality of user profiles and (ii) include content related to a predetermined product or service;
determining a point value for a content submission that is detected based on the monitoring, wherein the point value is based on at least: (i) a submission time of the content submission, and (ii) a sum of pledged amounts published by the crowdfunding platform prior to the submission time;
storing, in the data storage, user activity data indicating the determined point value, the submission time, and a mapping of the determined point value to a corresponding user profile;
receiving royalty distribution data (i) related to a sale of the particular product or service and (ii) indicative of a royalty amount and a distribution time;
based on stored point values in the user activity data associated with submission times prior to the distribution time, determining respective point balances of the plurality of user profiles;
allocating a portion of the royalty amount to the given user profile based on a ratio of a determined point balance of the given user profile to a sum of point balances of the plurality of user profiles; and
causing the given user interface to display an indication of the allocated portion of the royalty amount.

3. A method comprising:
a computing system monitoring, via a data communication network, aggregated content related to a predetermined product or service, wherein the aggregated content is dynamically updated and published by an electronic publishing platform that aggregates user-submitted content together with user identifiers for the user-submitted content;
storing, in data storage, a plurality of user profiles mapped to user activity data pertaining to the predetermined product or service, wherein a first user profile includes a first user identifier of a first user;
filtering, from the aggregated content, a plurality of content submissions having respective user identifiers corresponding to at least one of the stored plurality of user profiles;
for each filtered content submission having the first user identifier: (i) determining a point value based on at least a submission time of the content submission; and (ii) storing, in the user activity data, an indication of the determined point value mapped to the first user profile;
detecting a royalty distribution event (i) related to a sale of the predetermined product or service and (ii) indicative of a royalty amount and a distribution time;
based on the user activity data, determining (i) a first sum of point values that are mapped to the first user profile and correspond to content submissions prior to the distribution time, and (ii) a second sum of point values that are mapped to any of the plurality of user profiles and correspond to content submissions prior to the distribution time;
allocating a portion of the royalty amount to the first user profile based on at least a comparison of the first sum and the second sum; and
causing a user interface associated with the first user profile to display an indication of the allocated portion of the royalty amount.

4. The method of claim 3, further comprising:
prior to monitoring the aggregated content, causing the user interface associated with the first user profile to display an indication of the electronic publishing platform and a start time for monitoring the aggregated content,
wherein, for each content submission having the first user identifier, determining the point value is based on a difference between the start time and the submission time of the content submission.

5. The method of claim 3, further comprising:
causing the user interface associated with the first user profile to display an indication of the electronic publishing platform and a predefined time window,
wherein, for each content submission having the first user identifier, determining the point value is based on whether the submission time of the content submission is within the predefined time window.

6. The method of claim 3, further comprising:
determining, for the first user profile, a user-specific point multiplier based on at least (i) a number of content submissions mapped to the first user profile and indicated in the user activity data pertaining to the predetermined product or service, and (ii) a number of content submissions mapped to the first user profile and indicated in other stored user activity data pertaining to another product or service; and
storing, in the data storage, an indication of the user-specific point multiplier,
wherein, for each content submission having the first user identifier, determining the point value is based also on the user-specific point multiplier.

7. The method of claim 3, further comprising, for each content submission having the first user identifier:
determining, based on the user activity data, a number of content submissions: (i) related to the predetermined product or service, (ii) mapped to any of the plurality of user profiles, and (iii) having respective submission times prior to the submission time of the content submission,
wherein determining the point value is based also on the determined number of content submissions.

8. The method of claim 3, further comprising:
causing the user interface associated with the first user profile to display an indication of downloadable media content related to the predetermined product or service, and a point multiplier for content submissions that incorporate the downloadable media content; and
for each content submission having the first user identifier, determining whether the content submission includes the downloadable media content,
wherein determining the point value is based also on the point multiplier responsive to a determination that the content submission includes the downloadable media content.

9. The method of claim 3, wherein the determined point value is a first point value, the method further comprising:
prior to the data storage storing the first user profile in the plurality of user profiles, receiving, via a second user interface associated with a second user profile, an input indicating a referral invitation for the first user;
storing, in the data storage, the first user profile including an indication of the second user profile as a referring user profile for the first user profile; and
for each content submission having the first user identifier:
based on a determination that the first user profile includes the indication of the second user profile, determining a second point value as a predefined percentage of the determined first value; and
storing, in the user activity data, an indication of the second point value mapped to the second user profile.

10. The method of claim 9, further comprising, for each content submission having the first user identifier:
based on a determination that the second user profile includes an indication of a third user profile as a referring user profile for the second user profile, determining a third point value based on the determined first value; and
storing, in the user activity data, an indication of the third point value mapped to the third user profile.

11. The method of claim 3, wherein detecting the royalty distribution event comprises:
receiving, from a remote server via the data communication network, a message indicating the royalty amount; and
determining the distribution time based on a time of receipt of the message from the remote server.

12. The method of claim 11, wherein the remote server provides the message in response to detection of the sale of the predetermined product or service via an internet store web site.

13. The method of claim 3, further comprising:
causing an administrator user interface for an administrator user profile to display an indication of the predetermined product or service,
wherein detecting the royalty distribution event comprises receiving an input via the administrator user interface.

14. The method of claim 3, further comprising:
based on the monitoring, detecting an update to the aggregated content, the update pertaining to a given content submission being aggregated with other content submissions previously included in the aggregated content; and
in response to detecting the update, assigning a submission time for the given content submission based on a time of detection of the update.

15. The method of claim 3, further comprising:
determining respective submission times of the plurality of content submissions based on data included in the aggregated content.

16. The method of claim 3, wherein the electronic publishing platform comprises a crowdfunding platform, wherein the aggregated content is indicative of user-pledged amounts published via the crowdfunding platform for a project related to the predetermined product or service, the method further comprising:
determining a sum of the user-pledged amounts indicated in the aggregated content,
wherein, for each content submission having the first user identifier, determining the point value is also based on the determined sum.

17. The method of claim 16, further comprising:
determining whether the sum of the user-pledged amounts exceeds a target amount,
wherein, for each content submission having the first user identifier, determining the point value is also based on the determination of whether the sum of the user-pledged amounts exceeds the target amount.

18. The method of claim 3, wherein the electronic publishing platform comprises a social networking platform, wherein the aggregated content comprises social network content submissions by one or more social network users.

19. The method of claim 18, further comprising:
identifying, in the aggregated content, a social network response to a given content submission of the plurality of content submissions, wherein the given content submission has the first user identifier;
responsively determining a second point value based on at least a response submission time of the social network response; and
storing, in the user activity data, an indication of the second point value mapped to the first user profile.

20. The method of claim 18, further comprising:
causing the user interface associated with the first user profile to display an indication of a social network tag related to the predetermined product or service,
wherein filtering the plurality of content submissions is based on the plurality of content submissions including the social network tag.
